(19) United States
(12) Patent Application Publication
(10) Pub. No.: US 2015/0017618 A1
(43) Pub. Date: Jan. 15, 2015

(54) PSYCHOLOGICAL PROFILING SYSTEMS AND METHODS

(71) Applicant: Old Mission Holdings, LLC, Denver, CO (US)

(72) Inventor: Steven Thomas Portenga, Denver, CO (US)

(21) Appl. No.: 14/327,093

(22) Filed: Jul. 9, 2014

Related U.S. Application Data
(60) Provisional application No. 61/844,257, filed on Jul. 9, 2013.

(51) Int. Cl. G09B 19/00; G09B 5/00

(52) U.S. Cl. CPC G09B 19/00; G09B 5/00
USPC 434/236

(57) ABSTRACT

A system, method, and software product psychologically profile an athlete using a mobile device. Data collected from the athlete using an app running on the mobile device is received and processed to determine a psychological profile score and at least one activity to train the athlete is provided based upon the psychological profile score.

### RELATED APPLICATIONS

This application claims priority to U.S. Patent Application Ser. No. 61/844,257, titled “Psychological Profiling Systems and Methods”, filed Jul. 9, 2013, and incorporated herein by reference.

### BACKGROUND

Athletes require both physical and psychological strength to perform well. Psychological training of an athlete requires direct contact between the athlete and the psychologist to allow the psychologist to build a psychological profile of the athlete and to provide psychological training activities for the athlete based upon the psychological profile. The athlete benefits from the experience of the psychologist in (a) recognizing behavior of the athlete before, during, and after an athletic performance and (b) providing activities to build on the athlete's psychological strength. Such psychological training requires many periods of contact between the athlete and the psychologist to continually update the athlete's psychological profile.

### SUMMARY OF THE INVENTION

The systems and methods disclosed herein provide a mobile utility for training athletes, both professional and amateur, to help them reach their full potential, to overcome obstacles in learning and growth, and to help assess, diagnose, and monitor changes. The systems and methods utilize sport and performance psychology assessments, meditations, exercises, worksheets, games, and routines that collectively act as a personal advisor and trainer for athletes (e.g., professional and amateur athletes) wishing to improve their mental preparation and focus for sporting events. A psychological profile of the athlete is developed by assessing (a) the athlete's answers to questions, and (b) the athlete's pattern of usage of the device.

The mobile utility is applicable to all performance domains (all major and minor sports, performing arts, medical, high risk occupations, and business offers) including:
Mental training in seven different skills: Attentional Control, Energy Regulation, Imagery, Commitment, Concentration, Confidence, and Composure
Initial evaluations that help guide the athlete in training
Skill Training meditations, worksheets, and exercises to guide the athlete through preparations
a concentration grid game
GameDay functionality allowing the athlete to setup routines for the big race, game, or performance
a report to show the athlete areas where of strength and areas upon which to focus for improvement

In one embodiment, a method psychologically profiles an athlete using a mobile device. Data collected from the athlete using an app running on the mobile device is received and processed to determine a psychological profile score, and at least one activity to train the athlete is provided based upon the psychological profile score.

In another embodiment, a system psychologically profiles an athlete using a mobile device. The system includes an app having machine readable instructions that when stored within a memory of the mobile device and executable by a processor of the mobile device is capable of: collecting data when the athlete interacts with the app on the mobile device, sending the data to a server that processes the data to determine a psychological profile score of the athlete, receiving the psychological profile score from the server, and providing an activity to train the athlete based upon the psychological profile score.

In another embodiment, a software product has instructions, stored on non-transitory computer-readable media, wherein the instructions, when executed by a computer, perform steps for psychologically profiling an athlete. The software product includes: instructions for receiving data from the athlete interacting with a mobile device, instructions for processing the data to determine a psychological profile score of the athlete, and instructions for providing at least one activity to train the athlete.

### BRIEF DESCRIPTION OF THE FIGURES

FIG. 1 shows one exemplary psychological profiling system for training an athlete, in an embodiment.

FIG. 2 shows the user data of FIG. 1, as stored within the memory of the server, in further exemplary detail.

FIG. 3 shows the usage data of FIGS. 1 and 2 in further exemplary detail.

FIG. 4 shows exemplary psychological profile components and their associated activities that form the psychological analysis performed by the system of FIG. 1, in an embodiment.

FIG. 5 shows the psychological profiler of FIG. 1 in further exemplary detail.

FIG. 6 is a flowchart illustrating one exemplary psychological profiling method, in an embodiment.

FIG. 7 shows one exemplary psychological profiling system for training an athlete, in an embodiment.

### DETAILED DESCRIPTION OF THE EMBODIMENTS

In the following examples, an athlete uses an app running on a mobile device. However, the benefits of the systems and methods described herein are not limited to only athletes; any user of the app running on the mobile device may similarly benefit. Thus, the term athlete, as used hereinafter, refers to any user of the described mobile devices.

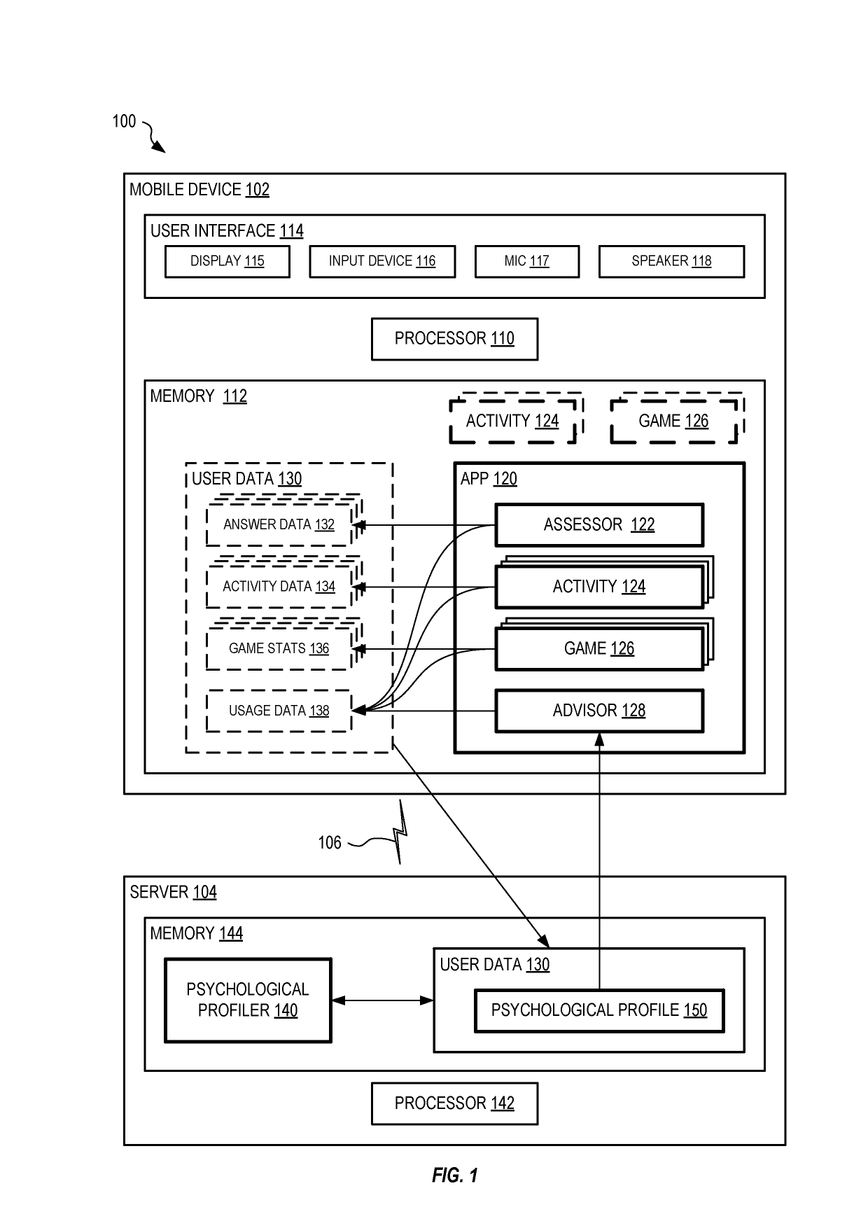

FIG. 1 shows one exemplary psychological profiling system 100 for training an athlete. System 100 includes a mobile device 102 that communicates with a server 104 via a network 106. Mobile device 102 is for example one of: a smart phone, a tablet computer, a notebook computer, or other portable communication type device. Mobile device 102 includes a processor 110, a memory 112, and a user interface 114. User interface 114 may include one or more of a display 115, an input device 116, a microphone 117, and a speaker 118. Display 115 and input device 116 may combine to operate as a touch screen, as found on many smart phones and tablet computers for example. Mobile device 102 is configured with an application (app) 120 that includes one or more software modules chosen from the group of software modules comprising: an assessor 122, at least one activity 124, at least one game 126, and an advisor 128. Where mobile device 102 is a smart phone, app 120 is for example downloaded from an app store. App 120 has machine readable instructions stored within memory 112 that are executed by processor 110 to provide functionality of assessor 122, activity 124, games 126, and advisor 128, as described below.

Optionally, one or more activities 124 and/or games 126 are implemented as independent applications (apps) running on mobile device 102 that update user data 130 directly or via app 120. These independent activities 124 and/or games 126 may also communicate directly with server 104, and/or via app 120, to update user data 130 stored within memory 144 of server 104.

Network 106 may include one or more of: a cellular network (e.g., GSM, CDMA), a wireless network (e.g., Wi-Fi, WAN, Bluetooth), a wired network (e.g., Ethernet, LAN), the Internet, and any other data carrying type networks that facilitates communication between a mobile device and a cloud based server.

Within mobile device 102, app 120 operates to collect user data 130 based upon the athlete's use of mobile device 102, and in particular based upon the athlete's interaction, using user interface 114, with one or more of assessor 122, activity 124, game 126, and advisor 128.

Assessor 122 presents one or more sets of questions to the athlete and stores answer data 132 within memory 112 to form at least a part of user data 130. In one example of operation, assessor 122 interacts with the athlete to receive responses for a first set of questions to determine answer data 132 that is used to generate an initial psychological assessment of the athlete. In another example of operation, assessor 122 interacts with the athlete to receive responses for questions associated with one or more components of a basic psychological profile. Basic psychological profile components may include: attention control, energy regulation, imagery, commitment, concentration, confidence, and composure.

Activity 124 represents a specifically designed activity for the athlete to participate in, wherein activity data 134 (e.g., biofeedback) is collected based upon the response of the athlete to activity 124. Exemplary activities 124 are provided below and may include worksheets and other interactive exercises that are completed by the athlete.

Each of assessor 122, activity 124, game 126, and advisor 128 operates to also collect usage data 138 that includes statistics of the athlete's interaction with mobile device 102, and in particular of the athlete's interaction with app 120. Usage data 138 may include information such as the number of times app 120 has been initiated by the athlete, the interval between these initiations, a number of times the instructions have been read, the operational period, and other information related to usage of app 120 that would be appreciated by those in the art. Usage data 138 may be provided for each psychological profile component, each activity 124, each game 126, and/or each other section of app 120.

Usage data 138 includes statistics of how the athlete interacts with app 120, and in particular how the athlete interacts with each activity 124. For example, usage data 138 may include, for app 120 and for each activity 124, one or more of: usage date, duration of use, and a count of uses. Usage data 138 may also include statistics of whether the athlete reads the skill overview, whether the athlete reads the directions before beginning an exercise, and whether the athlete reads the “more information” section of the app. Usage data 138 may also contain statistics on one or more of: whether the athlete takes an assessment too fast to be a thoughtful process, whether the athlete retries or stops playing a game if they do not do well, how the athlete's reaction time changes after making an error in comparison to their normal reaction time, and whether the athlete opens a GameDay schedule on days with scheduled performances.

The athlete interacts with game 126 using user interface 114, whereupon game 126 collects and stores game statistics 136 within memory 112 to form at least a part of user data 130. Game statistics 136 may include athlete performance results (e.g., time to complete, game difficulty level, and response times) collected during playing of the game.

Server 104 is a computer with a processor 142 and memory 144 and is located remote from mobile device 102. Server 104 is for example located within “the Cloud” and/or is accessible via the Internet or other wireless connection such as over a cellular data network. Server 104 includes a psychological profiler 140 that includes machine readable instructions stored within memory 144 and executable by processor 142 to determine a psychological profile 150 of the athlete of mobile device 102 based upon user data 130. User data 130 is sent from mobile device 102 to server 104 and stored within memory 144 of server 104. For example, a user may create an account within server 104 that is associated with mobile device 102, wherein user data 130 is then associated with the user's account within server 104. Server 104 may also allow the user to edit certain information (e.g., user profile and configuration data) of user data 130 by interacting (e.g., using a browser via the Internet) with server 104.

Profiler 140 processes user data 130 and generates psychological profile 150 within user data 130 of memory 144. Mobile device 102 sends user data 130 to server 104 when it is updated based upon athlete interaction with app 120. In one example of operation, app 120 sends user data 130 to server 104 when the athlete opens or closes app 120 on mobile device 102. In another example of operation, app 120 retrieves psychological profile 150 from server 104 when the athlete request advice from advisor 128 within app 120, wherein advisor 128 provides advice and recommendations to the athlete based upon the determined psychological profile 150. For example, based upon the athlete's interaction and psychological profile 150, advisor 128 may unlock new activities, suggest assessments, activities, and games for the athlete to use, and may recommend a schedule of how many times, and when to take each assessment, activity, and game. As the athlete progresses, for example, advisor 128 may unlock and recommend more advanced activities and games for the athlete to participate in.

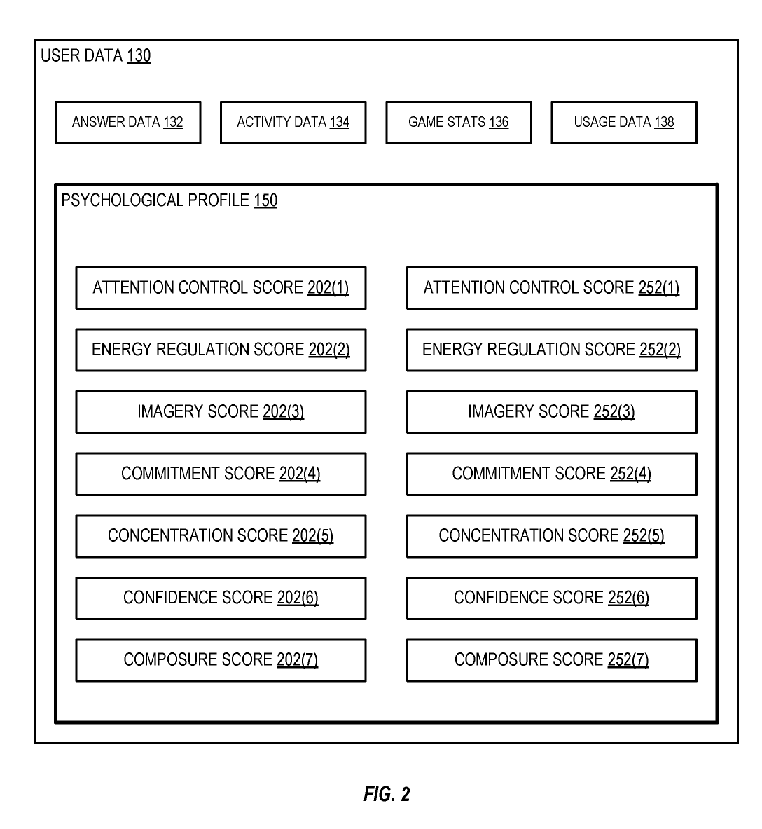

FIG. 2 shows user data 130 of FIG. 1, as stored within memory 144 of server 104, in further exemplary detail. User data 130 includes answer data 132, activity data 134, game statistics 136, and usage data 138, as collected by app 120 running on mobile device 102. Profiler 140 generates psychological profile 150 to include initial component scores 202, based upon answer data 132, and current component scores 252, based upon initial component scores 202 and activity data 134, game statistics 136, and usage data 138. Each of initial component scores 202 and current component scores 252 includes at least one score for each psychologically profiled component. In the example of FIG. 2, initial component scores 202 include an initial attention control score 202(1), an initial energy regulation score 202(2), an initial imagery score 202(3), an initial commitment score 202(4), an initial concentration score 202(5), an initial confidence score 202(6), and an initial composure score 202(7), and current component scores 252 include an attention control score 252(1), an energy regulation score 252(2), an imagery score 252(3), a commitment score 252(4), a concentration score 252(5), a confidence score 252(6), and a composure score 252(7).

Current component scores 252 are updated based upon the athlete's use of app 120. For example, profiler 140 processes user data 130 to update current component scores 252 periodically based upon statistics and usage information contained within activity data 134, game statistics 136, and usage data 138. In one example of operation, profiler 140 analyzes text provided by the athlete within text boxes of app 120 to identify patterns of words used therein and correlate these words with outcomes of the athlete training. For example, profiler 140 may search for words that are statistically related to low or high scores of a particular activity 124, wherein the presence of the identified words within text boxes may be used to increase or decrease the current component score 252 associated with that activity. Profiler 140 may update current component scores 252 when the athlete requests, using app 120, a report of psychological profile 150, and optionally when new user data 130 is received within server 104.

Optionally, biofeedback information may be collected and included within user data 130 by one or more biofeedback devices that couple with mobile device 102. For example, a heart rate monitor may couple (e.g. through wireless or wired coupling) with mobile device 102 and detect a heart rate of the athlete during use of app 120. The biofeedback device may also couple wirelessly with server 104 rather than mobile device 102, to provide biometric information of the athlete. In one embodiment, the biometric feedback device provides one or more of: heart rate variability information of the athlete, muscle tension information, skin temperature information, and brain wave information.

In one example of operation, the biometric feedback device collects biometric feedback information of the athlete while the athlete participates in certain activities 124. In one embodiment, profiler 140 analyzes the relationship between the biometric feedback information and activity data 134 to enhance psychological profile 150. Profiler 140 may also utilize other information (e.g., age, gender, sport/performance result statistics) provided by the athlete to generate psychological profile 150.

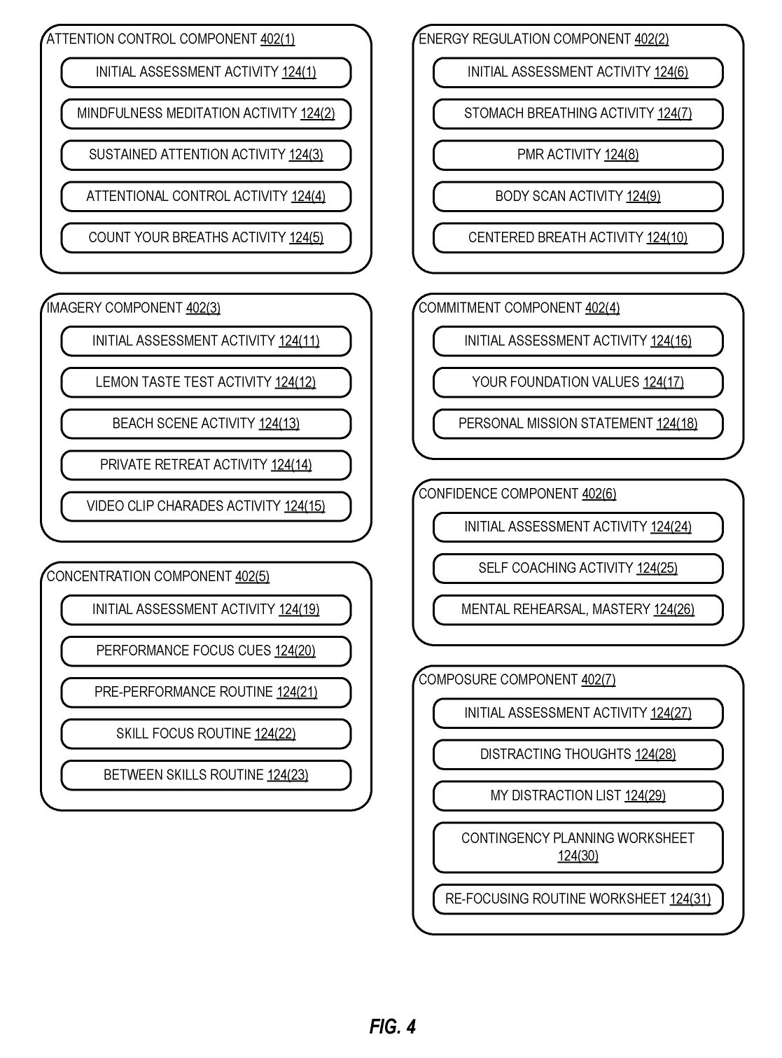

Profiler 140 may be updated and enhanced over time and based upon collected information within user data 130 for a broad spectrum of people. For example, as information is accumulated within server 104, algorithms of profiler 140 may be updated to provide more accurate and additional psychological information within psychological profile 150. Further, additional components 402 (see FIG. 4) and additional activities 124 corresponding thereto may be added based upon analysis of collected user data 130.

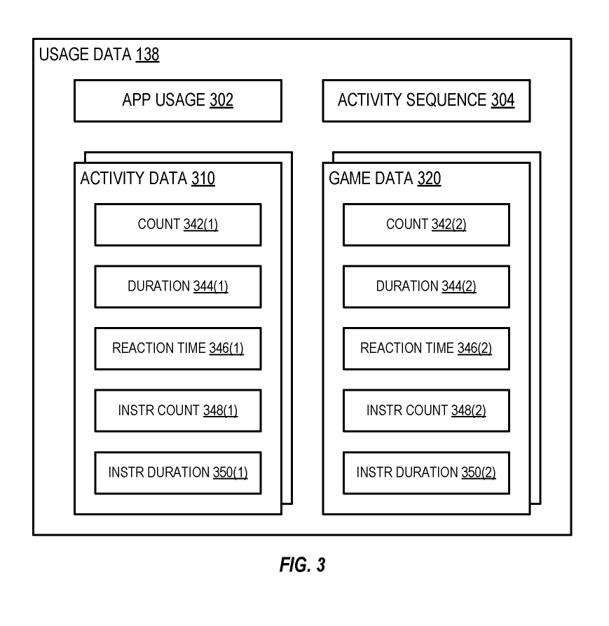

FIG. 3 shows usage data 138 of FIGS. 1 and 2 in further exemplary detail. Usage data 138 may include information such as app usage 302, an activity sequence 304, activity data 310, and game data 320. Activity data 310 includes a count 342(1), a duration 344(1), a reaction time 346(1), an instruction read count 348(1), and an instruction read duration 350(1) for each activity (e.g., questionnaires, meditations, worksheets, as so on). Similarly, game data 320 includes a count 342(2), a duration 344(2), a reaction time 346(2), an instruction read count 348(2), and an instruction read duration 350(2) for each game.

App 120 operates to generate app usage 302 to define the number of times the athlete has invoked app 120 on mobile device 102, and to generate activity sequence 304 to define the sequence in which the athlete invokes assessor 122, activities 124, games 126, and advisor 128, for example.

FIG. 4 shows exemplary psychological profile components 402 and their associated activities 124 that form the psychological analysis performed by system 100 of FIG. 1. Psychological profile components 402 are for example components used by psychological profiler 140 to generate psychological profile 150. An attention control component 402(1) has an initial assessment activity 124(1), a mindfulness meditation activity 124(2), a sustained attention activity 124(3), an attentional control activity 124(4), and a count your breaths activity 124(5). An energy regulation component 402(2) has an initial assessment activity 124(6), a stomach breathing activity 124(7), a progressive muscle relaxation (PMR) activity 124(8), a body scan activity 124(9), and a centered breath activity 124(10). An imagery component 402(3) has an initial assessment activity 124(11), a lemon taste test activity 124(12), a beach scene activity 124(13), a private retreat activity 124(14), and a video clip charades activity 124(15). A commitment component 402(4) has an initial assessment activity 124(16), a your foundation values activity 124(17), and a personal mission statement activity 124(18). A concentration component 402(5) has an initial assessment activity 124(19), a performance focus cues activity 124(20), a pre-performance routine activity 124(21), a skill focus routine activity 124(22), and a between skills routine activity 124(23). A confidence component 402(6) has an initial assessment activity 124(24), a self-coaching activity 124(25), and a mental rehearsal, mastery activity 124(26). A composure component 402(7) has an initial assessment activity 124(27), a distracting thoughts activity 124(28), a my distraction list activity 124(29), a contingency planning worksheet activity 124(30), and a re-focusing routine worksheet activity 124(31).

There are four general types of activity: assessments, activities, worksheets, and games. Assessments require the athlete to answer questions related to their experience of how psychological components interact with their performance. The training activities are experiential exercises for the athlete to undertake. These activities typically require practice and repetition for the athlete to learn the goal of the activity and to achieve the criteria for success. For example, a “stomach breathing” activity requires the athlete to repeat the exercise until they master breathing naturally using only their diaphragm muscles. Worksheets include questions that require depth of thought from the athlete to enter answers that fit best for them as an individual. These worksheets typically build upon one another to lead the athlete through a series of deep, meaningful questions that prepare them to perform at their best. Games are fun, interactive activities that are similar in nature to known smartphone game applications. Each game has one or more specific training and/or evaluative purposes and is created to train athletes in a fun, competitive manner that ensures compliance and provides enough repetition of the training and/or evaluation.

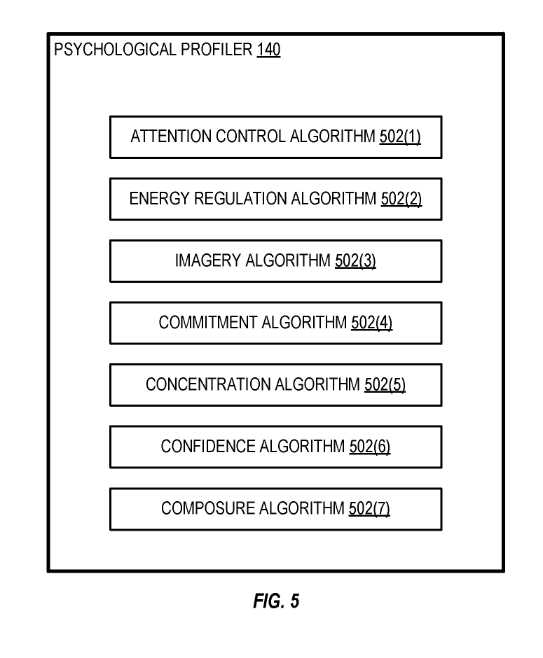

FIG. 5 shows psychological profiler 140 of FIG. 1 in further exemplary detail. Profiler 140 includes a plurality of scoring algorithms 502 that analyze user data 130 based upon one of components 402. In the example of FIG. 5, profiler 140 includes an attention control algorithm 502(1), an energy regulation algorithm 502(2), an imagery algorithm 502(3), a commitment algorithm 502(4), a concentration algorithm 502(5), a confidence algorithm 502(6), and a composure algorithm 502(7) that correspond to components 402(1)-(7), respectively. Scoring algorithms 502 generate current component scores 252 of FIG. 2. In particular, attention control algorithm 502(1) generates attention control score 252(1), energy regulation algorithm 502(2) generates energy regulation score 252(2), imagery algorithm 502(3) generates imagery score 252(3), commitment algorithm 502(4) generates commitment score 252(4), concentration algorithm 502(5) generates concentration score 252(5), confidence algorithm 502(6) generates confidence score 252(6), and composure algorithm 502(7) generates composure score 252(7).

Scoring algorithms 502 are based upon basic psychological profile components (e.g., one or more of components 402 of FIG. 4, such as: attention control, energy regulation, imagery, commitment, concentration, confidence, and composure) and each operates to update a corresponding current component score 252. In one embodiment, current component scores 252 each have a range of between 0 and 50. During execution of app 120, profile scores are displayed on display 115 as single digit values in the range between 1 and 9, where 1 represents a profile score in the range 0-9, 2 represents a profile score in the range 10-15, 3 represents a profile score in the range 16-20, 4 represents a profile score in the range 21-25, 5 represents a profile score in the range 26-35, 6 represents a profile score in the range 36-40, 7 represents a profile score in the range 41-45, 8 represents a profile score in the range 46-48, and 9 represents a profile score of 49-50.

Each current component score 252 within psychological profile 150 is determined from initial assessment score 202 and a score adjustment as shown in

Equation 1.

CurrentScore=InitialScore+ScoreAdjustment Equation 1

where
CurrentScore represents one of current component scores 252,
InitialScore represents one of initial component scores 202, and
ScoreAdjustment represents a value calculated by one of algorithms 502.

As described above, each initial score 202 is determined from the athlete's responses to an initial assessment activity where the athlete responds to a set of questions presented by assessor 122 for a particular psychological profile component 402. For example, initial assessment activity 124(1) includes a set of questions relating to attention control component 402(1).

TotalUsageCount is the sum of count 342(1) for each activity 124 associated with the particular component 402 during the given period, and Consistency is the smallest of the number of days since last use of each associated activity 124. ScoreAdjustment is calculated as:

ScoreAdjustment=UsageAdj+ConsistencyAdj Equation 2

where UsageAdj is initialized to zero. If in the last four weeks TotalUsageCount is less or equal to than fifteen, then UsageAdj is incremented by one. If in the last three weeks TotalUsageCount is less than or equal to four then UsageAdj is decremented by one. If UsageTime is greater or equal to five hours in the last four weeks, then UsageAdj is incremented by one.

ConsistencyAdj is minus-one if Consistency is greater than or equal to twenty-eight; otherwise ConsistencyAdj is zero.

UsageTime is the total time the athlete has spent interacting with each activity 124 associated with the particular component 402 during the given period.

Each algorithm 502 may be further configured to use data of activities 124 associated with the specific component 402 associated with the algorithm. Since each component 402 may have different associated activities 124, each algorithm 502 may be different, using more or fewer variables based upon the associated activities 124. For example, attention control algorithm 502(1) is associated with attention control component 402(1) and may use information of initial assessment activity 124(1), mindfulness meditation activity 124(2), sustained attention activity 124(3), attentional control activity 124(4), and count your breaths activity 124(5). Energy regulation algorithm 502(2) is associated with energy regulation component 402(2) and may use information of initial assessment activity 124(6), stomach breathing activity 124(7), PMR activity 124(8), body scan activity 124(9), and centered breath activity 124(10). Imagery algorithm 502(3) is associated with imagery component 402(3) and may use information of initial assessment activity 124(11), lemon taste test activity 124(12), beach scene activity 124(13), private retreat activity 124(14), and video clip charades activity 124(15). Commitment algorithm 502(4) is associated with commitment component 402(4) and may use information of initial assessment activity 124(16), your foundation values activity 124(17), and personal mission statement activity 124(18). Concentration algorithm 502(5) is associated with concentration component 402(5) and may use information of initial assessment activity 124(19), performance focus cues activity 124(20), pre-performance routine activity 124(21), skill focus routine activity 124(22), and between skills routine activity 124(23). Confidence algorithm 502(6) is associated with confidence component 402(6) and may use information of initial assessment activity 124(24), self-coaching activity 124(25), and mental rehearsal, mastery activity 124(26). Composure algorithm 502(7) is associated with composure component 402(7) and may use information of initial assessment activity 124(27), distracting thoughts activity 124(28), my distraction list activity 124(29), contingency planning worksheet activity 124(30), and re-focusing routine worksheet activity 124(31).

Exemplary Algorithm Customizations

In one embodiment, commitment algorithm 502(4) utilizes statistics of information provided within your foundation values activity 124(17) and personal mission statement activity 124(18). For example, rather than base the TotalUsageCount on the number of times the activities are opened, TotalUsageCount is calculated as:

Foundational Values_UsageNumber+PersonalMission_UsageNumber.

If the athlete has entered five foundation values within your foundation values activity 124(7), then:

Foundational Values_UsageNumber=5+NumberTimesValuesExerciseOpened

otherwise Foundational Values_UsageNumber is set to the number of foundation values entered into your foundation values activity 124(17) by the athlete. Foundation Values_UsageNumber is limited to a maximum value of ten.

If the athlete has entered text into a Feel WhenYouPerform text box of personal mission statement activity 124(18), and the athlete has selected more than three strengths, then:

PersonalMission_UsageNumber=NumberofStrengthsSelected+PMSTextBoxesEntered+NumberTimesPMSExerciseOpened

otherwise, PersonalMission_UsageNumber is set to the number of strengths selected by the athlete plus the number of PMS text boxes that have text added by the athlete. PersonalMission_UsageNumber is limited to a maximum value of twenty-one.

In one embodiment, concentration algorithm 502(5) utilizes statistics of information provided within one or more of performance focus cues activity 124(20), or performance routine activity 124(21), skill focus routine activity 124(22), and between skills routine activity 124(23). For example, rather than base the TotalUsageCount on the number of times these activities are opened, TotalUsageCount is calculated as:

PerformanceFocusCuesUseage+PrePerformanceRoutineUseage+SkillFocusRoutineUseage+BetweenSkillRoutineUseage+GeneralExecutionRoutineUseage+BetweenActionRoutineUseage

where PerformanceFocusCuesUseage is the number of performance cue entries made by the athlete, PrePerformanceRoutineUseage is set to zero and incremented for each of the following Boolean values that are set to true (i.e., checked) by the athlete: MasteryRehearsal, ContingencyRehearsal, and PracticedRelaxationTechnique. PrePerformanceRoutineUseage is further incremented by one for each of MorningNutritionTextBox MorningWarmUpTextBox, and EventWarmUpTextBox includes text provided by the athlete. PrePerformanceRoutineUseage is limited to a maximum value of 6.

SkillFocusRoutineUseage is set equal to NumberofPerformanceAffirmations₊NumberClosedSkillPerformanceFocusCues and incremented by one for each of CenteredBreathCueTextBox, EnergyLevelCueTextBox, and TrustCueTextBox that has text added by the athlete. SkillFocusRoutineUseage is further incremented by one if Boolean PerformanceFocusCuesCompleted is set to true. SkillFocusRoutineUseage has a maximum value of ten and a minimum value of six.

BetweenSkillRoutineUseage is set to NumberofGeneralAffirmations and incremented by one for each of Booleans PracticedCenteredBreath, PracticedMindfulnessMeditation, and PracticedEnergyRegualtion that are set to true. BetweenSkillRoutineUseage has a maximum value of six.

GeneralExecutionRoutineUseage is set to NumberofPerformanceAffirmations+NumberOpenSituationPerformanceFocusCues and incremented by one for each of CenteredBreathCueTextBox and EnergyLevelCueTextBox that has text added by the athlete. GeneralExecutionRoutineUseage is limited to a maximum value of eight and a minimum value of four.

BetweenActionRoutineUseage is set equal to NumberofGeneralAffirmations and incremented by one for each of Booleans PracticedCenteredBreath, PracticedMindfulnessMeditation, and PracticedEnergyRegualtion that are set to true.

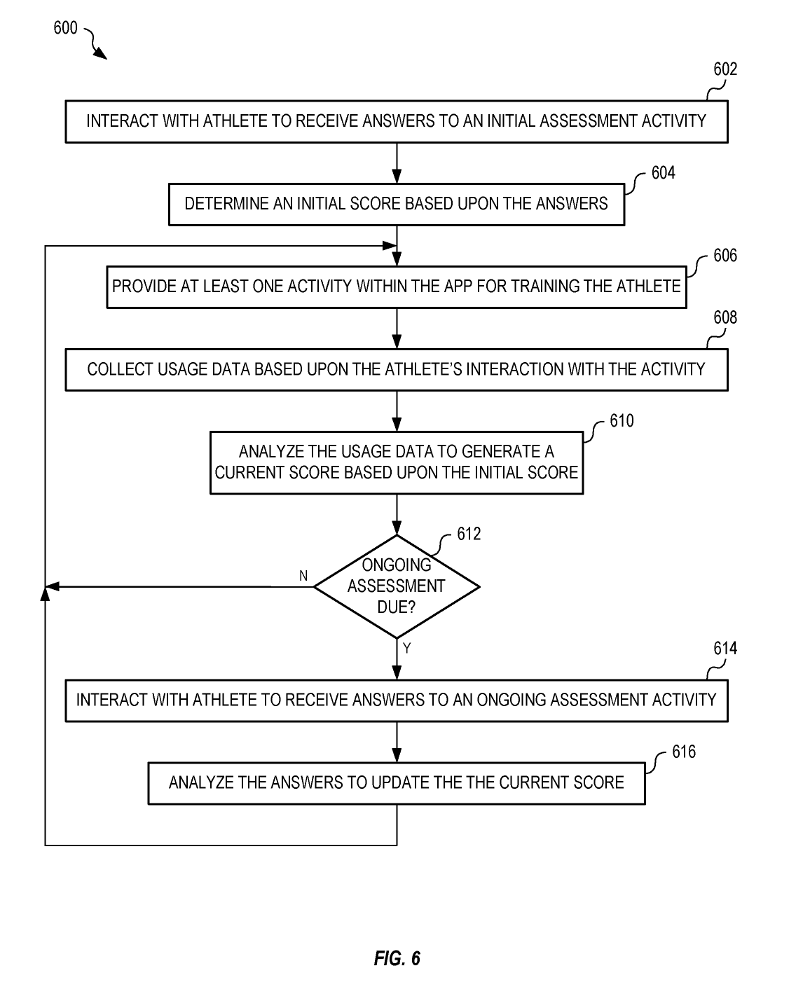

FIG. 6 is a flowchart illustrating one exemplary psychological profiling method 600. Part of method 600 is implemented within app 120 of FIG. 1, and part of method 600 is implemented within psychological profiler 140. Method 600 is shown for a single component 402 of a psychological profile and may be repeated for other profile components 402.

In step 602, method 600 interacts with an athlete to receive answers to an assessment activity. In one example of step 602, the athlete interacts with assessor 122, running within app 120 on mobile device 102, to provide answers to initial assessment activity 124(1) of attention control component 402(1).

In step 604, method 600 determines an initial score based upon the answers from step 602. In one example of step 604, assessor 122 determines initial attention control score 202(1) based upon answers to initial assessment activity 124(1).

In step 606, method 600 provides at least one activity within the app for training the athlete. In one example of step 606, activities 124(2)-(5) of attention control component 402(1) are enabled within app 120 when initial assessment activity 124(1) is completed by the athlete.

In step 608, method 600 collects usage data based upon the athlete's interaction with the activity. In one example of step 608, app usage 302, activity sequence 304, activity data 310, and game data 320 of usage data 138 are updated by one or more of assessor 122, activity 124, game 126 and advisor 128 as the athlete interacts with app 120.

In step 610, method 600 analyzes the usage data to generate a current score based upon the initial score. In one example of step 610, psychological profiler 140 analyzes usage data 138 to generate one or more of updates to initial scores 202 to generate current component scores 252.

Step 612 is a decision. If, in step 612, method 600 determines that an ongoing assessment is due, method 600 continues with step 614; otherwise method 600 continues with step 606.

In step 614, method 600 interacts with the athlete to receive answers to an ongoing assessment activity. In one example of step 614, assessor 122 is invoked to interact with the athlete and receive answers to additional questions associated with attention control component 402(1).

In step 616, method 600 analyzes the answers to update the current score. In one example of step 616, psychological profiler 140 analyzes answer data 132, activity data 134 game statistics 136, and usage data 138 to generate current component scores 252.

Method 600 then continues with step 606. Steps 606 through 616 repeat to periodically update psychological profile 150 based upon the athlete's use of app 120.

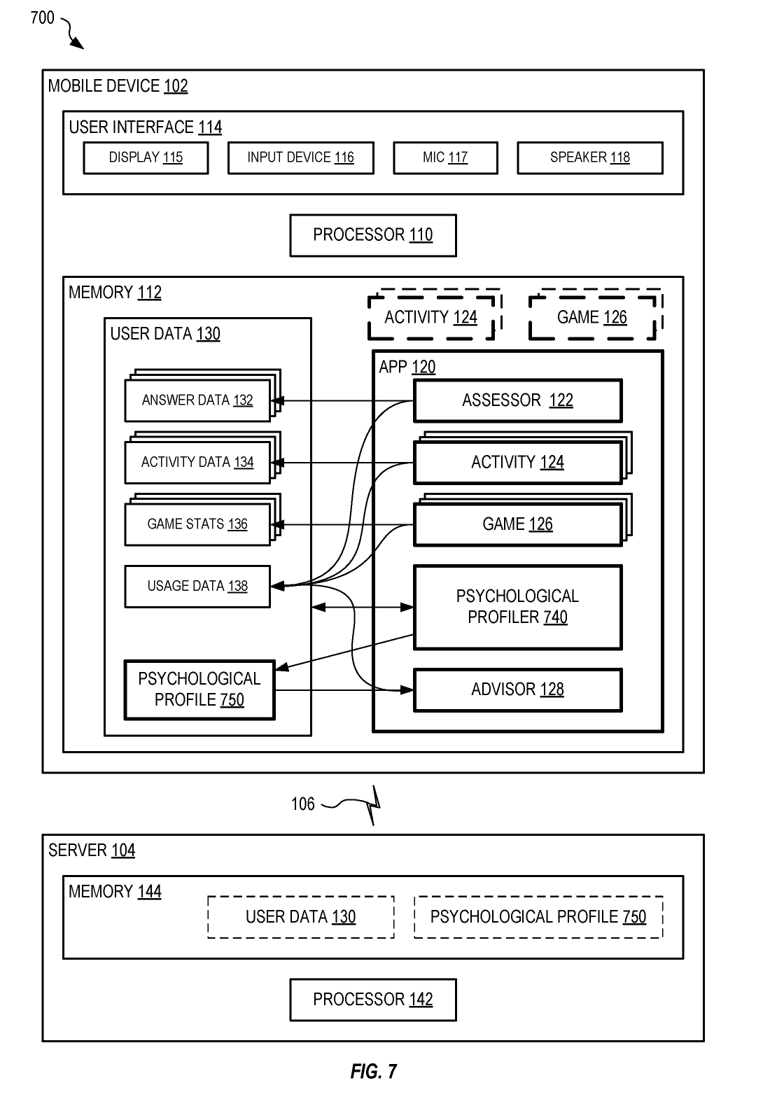

FIG. 7 shows one exemplary psychological profiling system 700 for training an athlete. System 700 is similar to system 100 of FIG. 1, except that a psychological profiler 740 is included within app 120, wherein profiler 740 operates to process user data 130 within mobile device 102 to generate a psychological profile 750. Profiler 740 is similar to profiler 140 of FIG. 1 and profile 750 is similar to psychological profile 150. Advisor 128 generates reports, displays, and provides advice to the athlete based upon profile 750.

Optionally, user data 130 and profile 750 are sent to server 104 for further processing and/or storage.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for psychologically profiling an athlete using a mobile device, comprising:
receiving data collected from the athlete using an app running on the mobile device;
processing the data to determine a psychological profile score; and
providing at least one activity to train the athlete based upon the psychological profile score.

2. The method of claim 1, the step of receiving comprising receiving answers, from the athlete, to a set of questions presented to the athlete by the app, and the step of processing comprising processing the answers to form an initial psychological profile score.

3. The method of claim 2, further comprising:
receiving performance results from the athlete's interaction with the activity;
processing the performance results to generate a score adjustment based upon the performance results; and
adjusting the psychological profile score based upon the score adjustment.

4. The method of claim 2, further comprising:
receiving usage data of the athlete using the app;
processing the usage data to determine a score adjustment; and
adjusting the psychological profile score based upon the score adjustment.

5. The method of claim 4, wherein the usage data comprises response times of the athlete using the app.

6. The method of claim 1, wherein the psychological profile score comprises a score for each of one or more psychological profile components selected from the group including attention control, energy regulation, imagery, commitment, concentration, confidence, and composure.

7. The method of claim 1, the data corresponding to one or more psychological profile components selected from the group including attention control, energy regulation, imagery, commitment, concentration, confidence, and composure.

8. The method of claim 1, further comprising providing advice and recommendations to the athlete based upon the psychological profile score.

9. A system for psychologically profiling an athlete using a mobile device, comprising:
an app comprising machine readable instructions that when stored within a memory of the mobile device and executable by a processor of the mobile device is capable of:
collecting data when the athlete interacts with the app on the mobile device;
sending the data to a server that processes the data to determine a psychological profile score of the athlete;
receiving the psychological profile score from the server; and
providing an activity to train the athlete based upon the psychological profile score.

10. The system of claim 9, the app further comprising machine readable instructions that when stored within the memory and executed by the processor are capable of:
collecting performance results from the athlete's interaction with the activity;
sending the performance results to the server for processing to generate a score adjustment for the psychological profile score; and
receiving an updated psychological profile from the server.

11. The system of claim 9, the app further comprising machine readable instructions that when stored within the memory and executed by the processor are capable of:
collecting usage statistics of the athlete using the app;
sending the usage statistics to the server for processing to generate a score adjustment for the psychological profile score; and
receiving an updated psychological profile from the server.

12. A software product comprising instructions, stored on non-transitory computer-readable media, wherein the instructions, when executed by a computer, perform steps for psychologically profiling an athlete, comprising:
instructions for receiving data from the athlete interacting with a mobile device;
instructions for processing the data to determine a psychological profile score of the athlete; and
instructions for providing at least one activity to train the athlete.

13. The software product of claim 12, the instructions for receiving comprising instructions for receiving answers, collected from the athlete, to a set of questions presented to the athlete by the app, and the instructions for processing comprising instructions for processing the answers to form an initial psychological profile score.

14. The software product of claim 12, further comprising:
instructions for receiving performance results from the athlete's interaction with the activity; and
instructions for processing the performance results to generate a score adjustment based upon the performance results;
wherein the psychological profile score is adjusted by the score adjustment.

15. The software product of claim 12, further comprising:
instructions for receiving usage data of the athlete using the app; and
instructions for processing the usage data to determine a score adjustment;
wherein the psychological profile score is adjusted by the score adjustment.

16. The software product of claim 15, wherein the usage data comprises response times of the athlete using the app.

17. The software product of claim 12, wherein the psychological profile score comprises a score for each of one or more psychological profile components selected from the group including attention control, energy regulation, imagery, commitment, concentration, confidence, and composure.

18. The software product of claim 12, the data corresponding to one or more psychological profile components selected from the group including attention control, energy regulation, imagery, commitment, concentration, confidence, and composure.

19. The software product of claim 12, further comprising instruction for providing advice and recommendations to the athlete based upon the psychological profile score.
